(19) United States
(12) Patent Application Publication
(10) Pub. No.: US 2018/0346670 A1
(43) Pub. Date: Dec. 6, 2018

(54) CAST-IN-PLACE PROTECTIVE SHEET AND ITS PREPARATION METHOD

(71) Applicant: Tianjin Qicai waterproofing material engineering Co., Ltd., Tianjin (CN)

(72) Inventors: Huiping LI, Tianjin (CN); Zhenghong SONG, Tianjin (CN); Xianting ZENG, Tianjin (CN); Yuanfu WANG, Tianjin (CN); Qizhi LI, Tianjin (CN); Meng LI, Tianjin (CN)

(73) Assignee: Tianjin Qicai waterproofing material engineering Co., Ltd., Tianjin (CN)

(21) Appl. No.: 15/721,642

(22) Filed: Sep. 29, 2017

(30) Foreign Application Priority Data
Jun. 1, 2017 (CN) 201710404975.4

(51) Int. Cl. C08J 5/18; C08G 18/76; C08G 18/48; C08G 18/38; C08G 18/24; C08K 13/02

(52) U.S. Cl. CPC C08J 5/18; C08G 18/7614; C08G 18/4812; C08K 2003/265; C08G 18/246; C08K 13/02; C08G 18/3819

(57) ABSTRACT

The present invention discloses a cast-in-place protective sheet, comprising the main ingredient taking up 45%-95% of the total by weight, which is composed of 125-140 parts of isocyanate, 10-220 parts of polyamine compound, 220-660 parts of diamine compound, 210-260 parts of polyether diol and 115-190 parts of polyether polyol, as well as the excipient taking up 5%-55% of the total by weight which is composed of 20-140 parts of environmental diluent, 1-35 parts of organometallic catalyst, 30-400 parts of filler and 4-75 parts of deforming agent. The present invention is an environmentally-friendly seamless waterproof material which has the advantages of strong adaptability to the environment, fast curing and good flexibility.

### CROSS-REFERENCE TO RELATED APPLICATION

This application claims the priority benefit of China application serial no. 201710404975.4, filed on Jun. 1, 2017. The entirety of the above-mentioned patent application is hereby incorporated by reference herein and made a part of this specification.

### BACKGROUND OF THE INVENTION

### Technical Field

The present invention relates to the technical field of waterproof material, and more specifically, to a functional building protection material for waterproof and anti-corrosion in construction projects.

### Description of Related Art

The building waterproof material is an important function of building products, which is related to the use value, service life and health conditions of a building, and has a direct impact on people's production activities as well as the quality of work and life. Therefore, it is relatively significant to ensure the quality of construction.

The increasing demands of people on quality of life as well as the development of science and technology are pushing new products and related engineering application technologies in the waterproof industry to develop rapidly from multi-layer to single layer and from hot construction to cold construction in a more convenient and environmentally friendly direction.

Currently, most waterproof materials are still roll-based and coating-based. The waterproof roll needs to fit the shape of waterproof bases in construction; several waterproof bases need to be joined together in case of a complex shape, and the coped joints and nodes generated in the cold and hot constructions using waterproof roll are the main parts that may cause hidden dangers such as leakage and water-moving; besides, after the completion of the constructions using waterproof roll, the local hidden damage on the waterproof layer caused by the subsequent process may also lead to the radioactive bulge, leakage, water-moving in these parts, making the waterproof function of the whole layer coherent with the waterproof layer decline in a large area, and in case of any damaged parts that cannot be found, the local patching program is not feasible, while the maintenance of enlarged areas may cause greater economic losses.

The waterproof coating can realize the holistic and seamless waterproofing, by virtue of its physical volatilization type, chemical reaction curing type, or both: The volatilization-type waterproof coating is more significantly impacted by the temperature and other factors, in that most of the volatile substances are pollutants and are limited by their applicable seasons; the reaction curing type has a harsh requirement on basic humidity in construction, with an extremely long time for reaction curing, and it is more significantly impacted by environmental changes or is easy to crack after curing.

### SUMMARY

In view of the foregoing, the present invention is aimed to provide an environmentally-friendly seamless waterproof material which is convenient in construction, has strong adaptability to the environment, is fast in curing, and has good flexibility.

In order to achieve the above objectives, the technical solution provided by the present invention is realized as follows:

A cast-in-place protective sheet comprises the main ingredient taking up 45%-95% of the total by weight, which is composed of 125-140 parts of isocyanate, 10-220 parts of polyamine compound, 220-660 parts of diamine compound, 210-260 parts of polyether diol and 115-190 parts of polyether polyol,

wherein the isocyanate is one or more of a mixture of xylylene diisocyanate (XDI), 4,4-diisocyanate, 2,4-diisocyanate, 2,2-diisocyanate and 1,6-hexamethylene diisocyanate;

the polyamine compound comprises one or more of primary amine, secondary amine and tertiary amine group-terminated polypropylene oxide compound with a functionality of ≥3 and a molecular weight of 100-6000;

the diamine compound comprises one or more of primary amine, secondary amine and tertiary amine group-terminated polypropylene oxide compound with a functionality of 2 and a molecular weight of 30-1800, and diethyltoluenediamine (DETDA);

the polyether diol comprises one or more of polyoxypropylene ether diol, ethylene oxide-terminated polyoxypropylenediol and tetrahydrofuran-polypropylene oxide copolyether (THF-PO);

the polyether polyol comprises one or more of polyoxypropylene ether triol, ethylene oxide-terminated polyoxypropylenetriol and pentaerythritol.

Preferably, in the polyamine compound, the diamine compound, the polyether diol, the polyether polyol, the ternary structure and the binary structure ratio is 1:1.15-1:1.3, and the terminal amino group and the terminal hydroxyl group ratio is 1.2:1-1.05:1.

In the above-mentioned main ingredient, the reaction of the unsaturated terminal amino compound and the unsaturated terminal hydroxyl compound with the isocyanate is inhibited by acid and then crosslinked under an alkaline condition; during the spraying process at a construction site, after the hydrophilic substance in the copolymer absorbs moisture in the air or in the building bases, the copolymer changes from acidity to basicity, and thus can undergo a secondary reaction to form a re-crosslinked structure under a catalytic condition; when the main ingredient is sprayed on the surface of building bases for many times or laid on the base carrier on the surface of building bases, a bubble-free and seamless cast-in-place protective sheet with a certain thickness will be formed. The appropriate copolymer, the chain extender and the crosslinking agent chosen in the main ingredient, as well as the controlled proportion of the reactive groups can provide the protective sheet with a suitable copolymerization chain length and a suitable distribution crosslinking center so as to ensure that the protective sheet has a suitable strength and good flexibility; in addition, an appropriate ternary or multi-structure also can ensure that the protective sheet can be rapidly glued and gel in the construction process, thus reducing the environmental interference, cracks, wrinkles and other adverse factors.

Furthermore, the cast-in-place protective sheet further comprises an excipient taking up 5%-55% of the total by weight and a remainder taking up 0-20%, and the sum of the main ingredient, the excipient and the remainder is 100%.

The excipient is composed of 20-140 parts of environmental diluent, 1-35 parts of organometallic catalyst, 30-400 parts of filler and 4-75 parts of deforming agent. The remainder is composed of 1-90 parts of functional adjuvant and 13-60 parts of inorganic dye.

The environmental diluent is one or more of dioctyl terephthalate, dioctyl phthalate, and dibutyl phthalate.

The organometallic catalyst is one or more of dibutyltindilaurate (T12), stannous octoate (T9), lead octoate, zinc octoate and calcium naphthenate.

The filler is one or more of calcium carbonate, light calcium carbonate, talc, kaolin and heavy calcium carbonate. Preferably, the fineness of the filler is 800-3000 mesh, which can ensure sufficient mixing and inclusion of the liquid material and the powder material to form a core-shell structure.

The defoaming agent is one or more of tributyl phosphate, methyl silicone oil and dimethyl silicone oil.

In the above-mentioned excipient, suitable diluents and deforming agents provide the protective sheet with a sprayed emulsified fluid with a suitable viscosity, concentration and fluidity; the filler is wrapped at the time of the reaction to form a core-shell structure to enhance the strength and elasticity of the protective sheet, which can prevent the protective sheet from bending and extending after formation; the organic metal catalyst can catalyze a reaction with the cooperation of the main ingredient and excipient, thus greatly reducing the non-stick (surface dry) time and gelling (full dry) time of the protective sheet.

The functional adjuvant is one or more of benzoic acid, bentonite, calcium oxide, zinc oxide, calcium hydroxide, KH-550, cement and silane hydrophobic agent, which plays a part in lubricating, preventing shrinks, replacing part of fillers and absorbing moisture and modifying the property.

The inorganic dye may be carbon black, aluminum oxide, titanium dioxide, chromium oxide or iron oxide, which is used for proper adjustment of the color of the protective sheet.

The protective sheet of the present invention is prepared by adding an isocyanate, a polyether diol and a polyether polyol to a reactor at a temperature of 80-85° C., mixing them at a speed of 80-150 rpm for 3 hours of reaction, and rapidly cooling the resultant to 50-60° C.; adding deforming agents and inorganic dyes, and adding 3-4 batches of polyamine compound and diamine compound from the raw material, uniformly mixing them at a speed of 80-150 r/min for 1 hour of reaction; measuring the percentage content of the isocyanate (—NCO %), and rapidly reducing the temperature to 25±5° C. when the measurement reaches 95-105% of the design value; diluting and mixing the functional additives, organic metal catalyst with the environmental diluent and then placing them all to the reactor, leaving them dispersed for 20 minutes at the same speed, and finally adding the dried filler for full mixing, filtration, protection with filled nitrogen and sealing.

In the present invention, “poly-” refers to three or more.

Comparing with the prior art, the present invention has strong adaptability to ambient temperature and basic (no water visible) humidity, and adopts the method of field spraying at the construction site for many times to prepare a seamless cast-in-place sheet with a certain thickness. It helps overcome the drawbacks such as too many coped joints and nodes in traditional roll, tendency to leak and difficulty in repairing, difficulty for a water-based coating to be dried to form a film due to temperature and seasonal effects, difficulty in forming a film or guaranteeing the quality of the film due to solvent evaporation, flammability of an oil coating and wet surface of bases. The protective sheet of the present invention has a non-stick (surface dry) time of less than 300 seconds, with the gelling (full dry) time of about 1 hour, and meanwhile the softness can be maintained at a low temperature of −35° C., thus meeting the needs of rapid construction and large-area seamless laying.

### DETAILED DESCRIPTION

The illustrative embodiments and related illustration of the present invention are intended to describe the present invention, and do not constitute an undue limitation of the present invention.

The raw materials of the constituent components in the embodiments are commercially available. In particular, the sources of each component in the embodiments are shown in Table 1.

TABLE 1

| Raw materials | Manufacturers | Product model |
|---|---|---|
| XDI | Mitsui Chemicals | D-110N |
| Ethylene oxide-terminated | Shandong | DL-2000D |
| polyoxypropylenediol | BluestarDongda Co., Ltd. | |
| Pentaerythritol | Yunnan Yuntianhua Co., | — |
| | Ltd. | |
| Tributyl phosphate | Wuxi Donghu Chemical | TBP |
| | Plant | |
| Titanium dioxide | LangfangShengquan | R-818 |
| | Chemical Co., Ltd. | |
| A polypropylene oxide | YantaiMinsheng | ATM-403 |
| compound with a primary | Chemical Co., Ltd. | |
| amine group terminated | | |
| with a functionality of 3 | | |
| DETDA | Jiangsu Victory Chemical | E-100 |
| | Co., Ltd. | |
| Dioctyl terephthalate | Jiangsu Weide Chemical | JSWD-SK50 |
| | Technology Co., Ltd. | |
| Benzoic acid | Tianjin Xin Da Yu | — |
| | Chemical Co., Ltd. | |
| Dibutyltindilaurate | Shanghai Yutian Chemical | T-12 |
| | Co., Ltd. | |
| Light calcium carbonate | Shijiazhuang Hongri | 1250 mesh |
| | Calcium Industry Co., Ltd. | |
| 2,4-diisocyanate | CangzhouDahua Group, | TDI-80 |
| | Hebei | |
| THF-PO | Shanxi Chemical | — |
| | Research Institute (Co., | |
| | Ltd.) | |
| Ethylene oxide-terminated | Shandong | MN-3050 |
| polyoxypropylenetriol | BluestarDongda Co., Ltd. | |
| Dimethyl silicone oil | Shenzhen Chuying New | 201 |
| | Material Co., Ltd | |
| Carbon black | Capel Chemical (Tianjin) | N774 |
| | Co., Ltd. | |
| Dibutyl phthalate | Jiangsu Weide Chemical | JSWD-DBP |
| | Technology Co., Ltd. | |
| Zinc oxide | Shijiazhuang Longli | — |
| | Chemical Co., Ltd. | |
| Stannous octoate | Shanghai Yutian | T-9 |
| | Chemical Co., Ltd. | |
| Talcum powder | LinyiZhenfang Chemical | 1250 mesh |
| | Co., Ltd. | |

### Embodiment 1

Adding 128 g of XDI, 210 g of ethylene oxide-terminated polyoxypropylenediol and 178 g of pentaerythritol to a reactor at a temperature of 80-85° C., mixing them at a speed of 80-150 rpm for 3 hours of reaction, and rapidly cooling the resultant to 50-60° C.; adding 15 g of tributyl phosphate and 40 g of titanium dioxide, and adding 3-4 batches of 70 g of primary amine-terminated polyoxypropane compound with a functionality of 3 and 40 g of DETDA, uniformly mixing them at a speed of 80-150 rpm for 1 hour of reaction; measuring the percentage content of the isocyanate (—NCO %), and rapidly reducing the temperature to 25±5° C. when the measurement reaches 95-105% of the design value; diluting and mixing 5 g of benzoic acid and 12 g of dibutyltindilaurate with 93 g of dioctyl terephthalate and then placing them all to the reactor, leaving them dispersed for 20 minutes at the same speed, and finally adding 300 g of dried light calcium carbonate for full mixing, filtration, protection with filled nitrogen and sealing into bottle for packaging.

Spraying the above-mentioned bottled material on the building bases that need to be protected for many times to prepare a seamless cast-in-place sheet with a thickness of 1.7 mm; after test, the non-stick time is 192 seconds, the gelling time is 3500 seconds and the tensile strength is 2.60 Mpa, with a breaking elongation of 680% and a low temperature flexibility of bending without cracks at a temperature of −35° C.

### Embodiment 2

Adding 125 g of 2,4-diisocyanate, 250 g of THF-PO and 135 g of ethylene oxide-terminated polyoxypropylenetriol to a reactor at a temperature of 80-85° C., mixing them at a speed of 80-150 rpm for 3 hours of reaction, and rapidly cooling the resultant to 50-60° C.; adding 25 g of dimethyl silicone oil and 36 g of carbon black, and adding 3-4 batches of 140 g of the primary amine-terminated polyoxypropylene compound with a functionality of 3 and 220 g of DETDA, uniformly mixing them at a speed of 80-150 rpm for 1 hour of reaction; measuring the percentage content of the isocyanate (—NCO %), and rapidly reducing the temperature to 25±5° C. when the measurement reaches 95-105% of the design value; diluting and mixing 21 g of zinc oxide and 25 g of stannous octoate with 64 g of dibutyl phthalate and then placing them all to the reactor, leaving them dispersed for 20 minutes at the same speed, and finally adding 290 g of dried talcum powder for full mixing, filtration, protection with filled nitrogen and sealing into bottle for packaging.

Spraying the above-mentioned bottled material on the building bases that need to be protected for many times to prepare a seamless cast-in-place sheet with a thickness of 1.7 mm; after test, the non-stick time is 206 seconds, the gelling time is 3700 seconds and the tensile strength is 2.55 Mpa, with a breaking elongation of 665% and a low temperature flexibility of bending without cracks at a temperature of −35° C.

The foregoings are only used as the preferred embodiments of the present invention and are not intended to limit the present invention, and any modifications, equivalent substitutions and improvements based on the spirit and principle of the present invention shall be covered in the protection scope of the present invention.

What is claimed is:

1. A composition for preparing a cast-in-place water-proof sheet material, the composition comprising:
45-95 wt % of a main ingredient, wherein a composition for preparing the main ingredient comprises:
125-140 parts by weight of an isocyanate;
10-220 parts by weight of a polyamine compound;
220-660 parts by weight of a diamine compound;
210-260 parts by weight of a polyether diol; and
115-190 parts by weight of a polyether polyol.

2. The composition of claim 1, wherein the isocyanate is xylylenediisocyanate, 4,4-diisocyanate, 2,4-diisocyanate, 2,2-diisocyanate, 1,6-hexamethylene diisocyanate or any combinations thereof;
the polyamine compound comprises one or more of primary amine, secondary amine and tertiary amine group-terminated polypropylene oxide compounds with a functionality of ≥3 and a molecular weight of 100-6000;
the diamine compound comprises one or more of primary amine, secondary amine and tertiary amine group-terminated polypropylene oxide compound with a functionality of 2 and a molecular weight of 30-1800;
the polyether diol comprises one or more of polyoxypropylene ether diol, ethylene oxide-terminated polyoxypropylenediol and tetrahydrofuran-polypropylene oxide copolyether; and
the polyether polyol comprises one or more of polyoxypropylene ether triol, ethylene oxide-terminated polyoxypropylenetriol and pentaerythritol.

3. The composition of claim 1, wherein
a molar ratio of a sum of the diamine compound and the polyether diol over a sum of the polyamine compound and the polyether polyol is from 1:1.15 to 1:1.3, and
a molar ratio of the terminal amino group over the terminal hydroxyl group is from 1.2:1 to 1.05:1.

4. The composition of claim 1, further comprising:
5-55 wt % of an excipient; and
0-20 wt % of a remainder.

5. The composition of claim 4, wherein
the excipient comprises:
20-140 parts by weight of an environmental diluent;
1-35 parts by weight of an organometallic catalyst;
30-400 parts by weight of a filler; and
4-75 parts by weight of a deforming agent; and
the remainder comprises:
1-90 parts of a functional adjuvant; and
13-60 parts of an inorganic dye.

6. The composition of claim 5, wherein
the environmental diluent is dioctyl terephthalate, dioctyl phthalate, dibutyl phthalate, or any combinations thereof;
the organometallic catalyst is dibutyltindilaurate, stannous octoate, lead octoate, zincoctoate, calcium naphthenate or any combinations thereof;
the filler is calcium carbonate, light calcium carbonate, talc, kaolin, heavy calcium carbonate, or any combinations thereof;
the defoaming agent is tributyl phosphate, methyl silicone oil, dimethyl silicone oil, or any combinations thereof;
the functional adjuvant is benzoic acid, bentonite, calcium oxide, zinc oxide, calcium hydroxide, KH-550, cement, silane hydrophobic agentl, or any combinations thereof; and
the inorganic dye is one or more of carbon black, aluminum oxide, titanium dioxide, chromium oxide, iron oxide, or any combinations thereof.

7. A method of preparing a cast-in-place water-proof sheet material, comprising:
adding 125-140 parts by weight of an isocyanate, 210-260 parts by weight of a polyether diol, and 115-190 parts by weight of a polyether polyol into a reactor at a temperature of 80-85° C. for reaction;
adding 4-75 parts by weight of a deforming agent and 13-60 parts of an inorganic dye into the reactor after the temperature thereof is decreased to 50-60° C.;
subsequently adding 10-220 parts by weight of a polyamine compound and 210-260 parts by weight of a polyether diol into the reactor for reaction;
measuring a percentage of isocyanate content in the reactor;
decreasing the temperature of the reactor to 25±5° C. after the isocyanate content is 95-105% of a designed value;
mixing and adding 1-90 parts by weight of a functional adjuvant, 1-35 parts by weight of an organometallic catalyst, and 20-140 parts by weight of an environmental diluent into the reactor to be dispersed in the reactor;
adding a dried filler into the reactor;
sufficiently mixing all components in the reactor to form a mixture;
filtering the mixture;
filling nitrogen into the mixture; and
sealing the mixture.

8. The method of claim 7, wherein
the isocyanate is xylylenediisocyanate, 4,4-diisocyanate, 2,4-diisocyanate, 2,2-diisocyanate, 1,6-hexamethylene diisocyanate or any combinations thereof;
the polyamine compound comprises one or more of primary amine, secondary amine and tertiary amine group-terminated polypropylene oxide compounds with a functionality of ≥3 and a molecular weight of 100-6000;
the diamine compound comprises one or more of primary amine, secondary amine and tertiary amine group-terminated polypropylene oxide compound with a functionality of 2 and a molecular weight of 30-1800;
the polyether diol comprises one or more of polyoxypropylene ether diol, ethylene oxide-terminated polyoxypropylenediol and tetrahydrofuran-polypropylene oxide copolyether; and
the polyether polyol comprises one or more of polyoxypropylene ether triol, ethylene oxide-terminated polyoxypropylenetriol and pentaerythritol.

9. The method of claim 7, wherein
a molar ratio of a sum of the diamine compound and the polyether diol over a sum of the polyamine compound and the polyether polyol is from 1:1.15 to 1:1.3, and
a molar ratio of the terminal amino group over the terminal hydroxyl group is from 1.2:1 to 1.05:1.

10. The method of claim 7, wherein
the environmental diluent is dioctyl terephthalate, dioctyl phthalate, dibutyl phthalate, or any combinations thereof;
the organometallic catalyst is dibutyltindilaurate, stannous octoate, lead octoate, zincoctoate, calcium naphthenate or any combinations thereof;
the filler is calcium carbonate, light calcium carbonate, talc, kaolin, heavy calcium carbonate, or any combinations thereof;
the defoaming agent is tributyl phosphate, methyl silicone oil, dimethyl silicone oil, or any combinations thereof;
the functional adjuvant is benzoic acid, bentonite, calcium oxide, zinc oxide, calcium hydroxide, KH-550, cement, silane hydrophobic agentl, or any combinations thereof; and
the inorganic dye is one or more of carbon black, aluminum oxide, titanium dioxide, chromium oxide, iron oxide, or any combinations thereof.
